(19) United States
(12) Patent Application Publication
(10) Pub. No.: US 2005/0096764 A1
(43) Pub. Date: May 5, 2005

(54) Sound-activated recording, transmission, and playback

(76) Inventor: Anatoly S. Weiser, San Diego, CA (US)

Correspondence Address: ANATOLY S. WEISER, ESQ, 674 VIA DE LA VALLE, SUITE 216, SOLANA BEACH, CA, 92075, US

(21) Appl. No.: 10/698,297

(22) Filed: Oct. 31, 2003

(51) Int. Cl. G06F 17/00

(52) U.S. Cl. 700/94

(57) ABSTRACT

A method and apparatus for sound recording, transmission, and reproduction eliminate periods of silence and prevent cut off of the leading edges of the sound segments. A recorder stores the sound in a First-In-First-Out (FIFO) device while monitoring the attributes of the sound, such as sound intensity level. When the attributes indicate that the sound should be recorded, the recorder transfers the contents of the FIFO onto a recording medium, and proceeds to record the incoming sound on the medium. When the attributes of the incoming sound indicate that a period of silence has begun, the recorder stops recording the sound on the recording medium, and begins to store the sound in the FIFO.

### BACKGROUND OF THE INVENTION

1. Field of the Invention

The present invention relates generally to sound recording, reproduction, and transmission methods and equipment, and, more particularly, to sound recorders, players, and transmitters with sound-activation capabilities.

2. Background

Many cassette recorders, telephone line monitors, and other sound loggers have voice activation capabilities. These systems attempt to record sound while minimizing periods of recorded silence and noise. Leaving out the periods of silence conserves the recording media, be it magnetic tape, semiconductor memory, or other media. Leaving out the periods of silence can also reduce power consumption and, consequently, reduce the need for battery recharging or replacement. Finally, it saves time when listening to the recorded sound.

Sound-activation is also used when sound is transmitted wirelessly, for example, from a cellular telephone. In these applications, leaving out the periods of silence has at least two potential benefits: (1) it conserves the average transmission power, extending battery life; and (2) it allows the cellular telephone system operator to decrease the average bandwidth used for a phone call and increase the call-handling capability of available bandwidth.

In a conventional cassette recorder with sound-activation capability, input sound level is monitored and, when the level exceeds a predetermined threshold, a relay activates a motor of the recorder. The motor pulls the magnetic tape on which the sound is recorded. When the sound level falls below the threshold, the relay disengages the motor, preventing recording of periods of silence and low-level sound/noise (hereinafter referred to using “effective silence periods,” “effective sound absence,” and similar expressions). Because activation of electrical motors takes some time, the recording may miss a short initial sound interval at the beginning of each sound segment. For this reason, some recorders use a bucket brigade device (BBD). The BBD-equipped sound recorders store sound in the BBD before transferring it onto the magnetic tape, so that the BBD captures the sound from the point of detection of the sound to the point when the electric motor begins to pull the magnetic tape.

Voice-activated digital recorders are also known. These devices monitor and record the sound on digital media when sound level exceeds a predetermined threshold. Recording stops when the sound level falls below the threshold.

Setting the threshold level is a compromise. The higher the threshold setting is, the more sound will be missed at the beginning of each sound segment. The lower the threshold setting is, the longer the recorded periods of effective sound absence will be. Practically, wherever the threshold level is set, the recorder will record some periods of silence or low-level noise, and also cut off the leading interval of each sound segment. When a person listens to a conversation recorded using the voice activation feature, the first word after each period of silence is often unintelligible, cut off in whole or in part. This is annoying and may cause the person not to understand the recorded conversation. It would be desirable to reduce or eliminate the missed intervals of sound at the leading periods of the recorded sound segments.

As has already been mentioned, known voice-activation recording methods generally rely on threshold detection to distinguish between sound segments and periods of silence. Using more complicated methods for distinguishing between silence and sound segments may be difficult in sound-activated real-time devices, such as recorders. Indeed, even a moderately-involved algorithm for deciding whether to record sound can extend the missed leading intervals of the sound segments to unacceptable lengths. It would be desirable to enable voice-activated recorders to use more complicated algorithms for distinguishing between sound and silence segments.

A need thus exists for voice-activated sound recorders that do not cut off sound when resuming recording after a period of silence, or reduce the unrecorded (missed) intervals of sound at the leading edges of the sound segments.

Another need exists for voice-activated recorders that allow the use of relatively complicated algorithms for deciding whether to record the sound, and yet do not extend the missed leading intervals of the sound segments.

A further need exists for improved sound-activation techniques for use in sound transmission systems.

Yet another need exists for sound activation techniques that allow skipping of periods of silence during sound reproduction, while minimizing the intervals of skipped (missed) sound.

### SUMMARY

The present invention is directed to methods and apparatus that satisfy these needs. The invention includes a method of transferring incoming sound. The incoming sound is stored in a buffer, and its attributes are monitored. Indications of sound segment presence and effective sound absence in the incoming sound are produced, based on the sound's attributes. When the attributes produce an indication of sound segment presence, a predetermined interval of the sound in the buffer is transferred, for example, recorded on a recording medium, transmitted, or reproduced. The predetermined interval extends to a point in time when the indication is produced. The sound following the indication is also transferred, until the attributes produce an indication of effective sound absence.

A sound recorder in accordance with the invention includes a microphone and an analog-to-digital converter. The microphone receives audio signals and generates analog waveforms corresponding to the audio signals. The analog-to-digital converter receives the analog waveforms from the microphone, and generates digitized waveforms from the analog waveforms. The recorder also includes a memory storing a program, and a processor, for example, a microcontroller, executing the program. The processor is coupled to an interface to a recording medium, such as a memory card controller. Under control of the program, the processor performs the following functions: (1) determines sound segments within the digitized waveforms; (2) causes the sound segments to be transferred through the interface to be recorded on the recording medium; and (3) causes a plurality of intervals of the digitized waveforms to be transferred through the interface, also to be recorded on the recording medium. Each interval immediately precedes one of the sound segments, and at least one interval is shorter than the time period between the sound segments immediately following and immediately preceding the at least one interval.

These and other features and aspects of the present invention will be better understood with reference to the following description, figures, and appended claims.

### BRIEF DESCRIPTION OF THE FIGURES

FIG. 1 illustrates selected steps of a process for sound-activated sound transfer in accordance with the present invention;

FIG. 2 illustrates a graph of sound intensity level of a sample sound signal;

FIG. 3 illustrates a graph of intensity of sound recorded with the process of FIG. 1 using the sample sound signal of FIG. 2;

FIG. 4 illustrates selected steps of a sound recording process where the decision to start recording the sound also generates an indication of the length of the pre-decision time interval to be recorded, in accordance with the present invention;

FIG. 5 illustrates selected steps of a process 500 for replaying a sound recording with user-selectable suppression of silent periods, in accordance with the present invention;

FIG. 6 is a high-level schematic diagram of an exemplary embodiment of a sound recorder and player in accordance with the present invention; and

FIG. 7 is a high-level schematic diagram of an exemplary embodiment of a wireless communication device in accordance with the present invention.

### DETAILED DESCRIPTION

Reference will now be made in detail to several embodiments of the invention that are illustrated in the accompanying drawings. Wherever possible, same or similar reference numerals are used in the drawings and the description to refer to the same or like parts or steps. The drawings are in simplified form and are not to precise scale. For purposes of convenience and clarity only, directional terms, such as top, bottom, left, right, up, down, over, above, below, beneath, rear, and front may be used with respect to the drawings. These and similar directional terms should not be construed to limit the scope of the invention in any manner. The words “connect,” “couple,” and similar terms with their inflectional morphemes do not necessarily denote direct and immediate connections, but also include connections through mediate elements or devices. Additionally, the terms “sound level” and “sound intensity level” are used interchangeably.

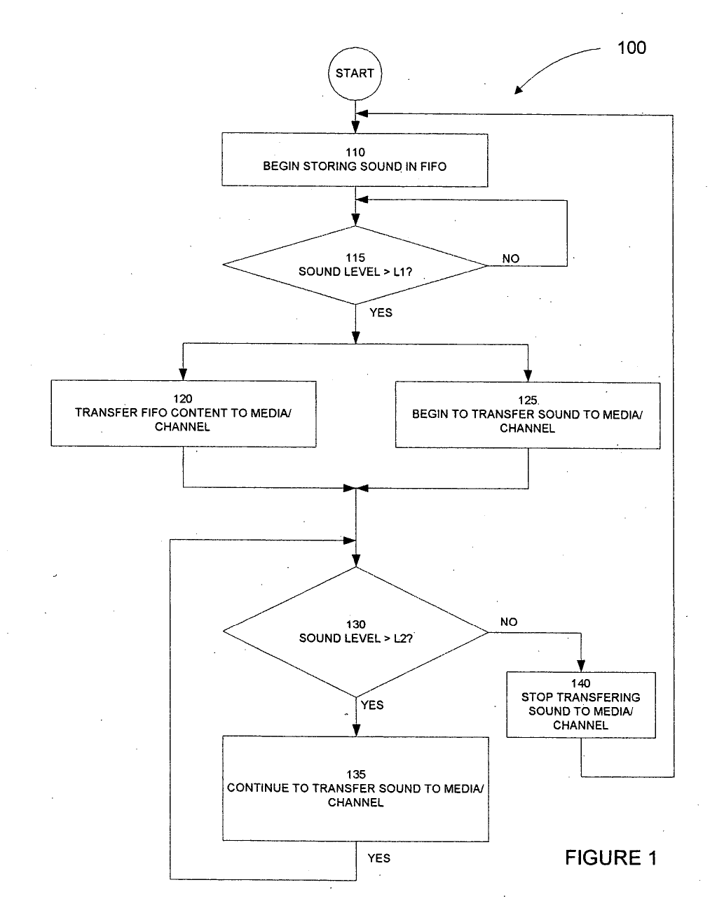

Referring more particularly to the drawings, FIG. 1 illustrates selected steps of a process 100 for sound-activated sound transfer in accordance with the present invention. (“Sound transfer” or simply “transfer” means the transfer of sound onto a recording medium, through a transmission channel, or through an audio reproduction channel.) At step 110, the storing of sound in a buffer, such as a First-In-First-Out (FIFO) device, is initiated. For example, the sound can be stored on a magnetic tape, memory card, charge-coupled device (CCD), random-access memory module used as a FIFO, dedicated digital FIFO, or BBD. At step 115, the sound level is tested against a predetermined limit L1. When the sound level exceeds L1, process flow advances to step 120, where the FIFO contents are transferred to the storage medium, e.g., the magnetic tape or memory card; or transferred to a channel, e.g., a wireless transmission channel. At step 125 (which can be performed in parallel with the step 120), a process for transferring the incoming sound to the storage medium or to the channel is initiated. In some embodiments in accordance with the present invention, storing of the sound in the FIFO can stop at this point, with the incoming sound being recorded directly on the recording medium.

Note that the buffer can be implemented as part of the recording medium, particularly if the recording medium is erasable.

While the sound continues to be transferred, the sound intensity level is monitored and tested against a predetermined limit L2, at step 130. As long as the sound level exceeds L2, the sound is transferred to the recording medium and/or through the channel, at step 135. When the sound level falls to or below L2, process flow proceeds to step 140, terminating the transfer of the incoming sound to the recording medium or the channel. The process flow then returns to the steps 110 and 115, once again storing the incoming sound in the FIFO and comparing the level of the sound to L1.

In the illustrated embodiment, L2 is slightly lower than L1, providing a degree of hysteresis to the decisions to begin and stop sound transfer. In another embodiment in accordance with the present invention, L2 is equal to L1, advantageously allowing the same comparator to be used in steps 115 and 130. In some embodiments in accordance with the invention, L2 can be greater than L1.

A person skilled in the art would recognize that, depending on the design of the apparatus performing the steps of the process 100 and the bandwidth of the transfer channel, the sound may go through the FIFO at all times, particularly when the rate of transfer is substantially the same as the rate actually needed to transfer the sound. In such case, the apparatus lags behind real time in transferring the sound. The duration of the lag interval is the period of time corresponding to the sound in the FIFO that needs to be transferred when the transfer of incoming sound is initiated in step 125. This period can be the entire length of the FIFO, or some portion of the FIFO. Consequently, the sound continues to be transferred after the sound level falls below L2; sound transfer continues until all sound is transferred up to the point in time when the sound level fell to or below L2.

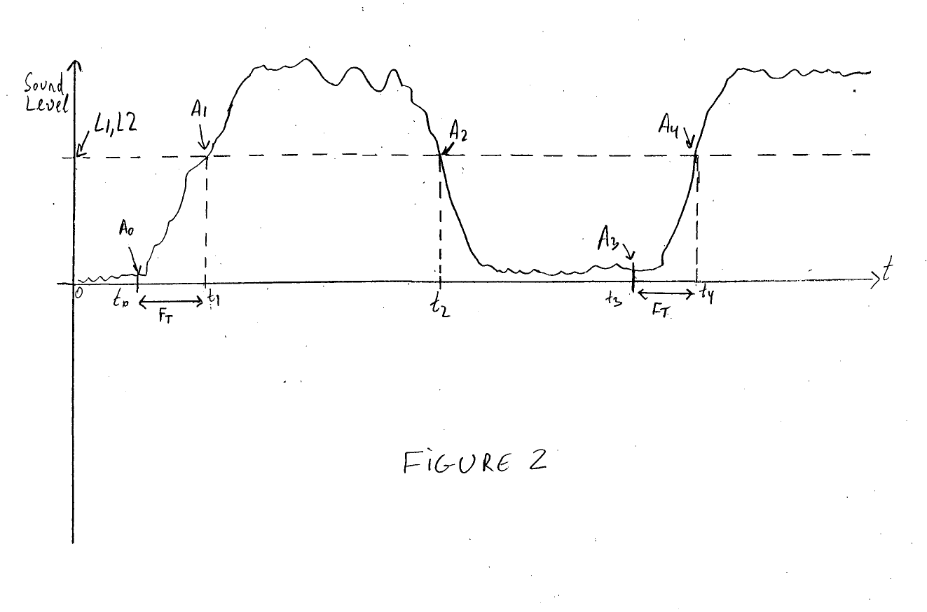

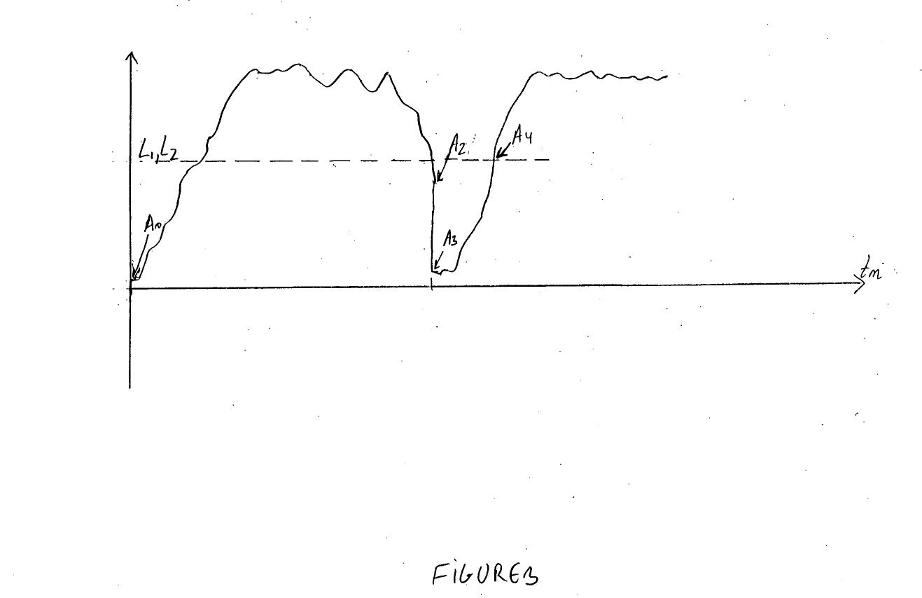

Operation of the process 100 is further illustrated with reference to FIGS. 2 and 3, which depict, respectively, a sample sound level graph of an input sound signal, and a graph of the sound level recorded on a recoding medium using the process 100. As can be seen from FIG. 2, the sound intensity level stays below L1 from t=0 to t=t₁. During this time, the sound is stored in the FIFO. The FIFO need not be able to store the entire time interval between 0 and t₁, but can accommodate just a part of this interval. As illustrated in FIGS. 2 and 3, the length of the FIFO is F_{T}<t₁. The FIFO in this case is circular, and the latest incoming sound effectively overwrites the oldest sound stored in the FIFO.

When the apparatus performing the process 100 detects sound level in excess of L1 at t=t₁, it transfers the contents of the FIFO to the recording medium (step 120), and continues to record the incoming sound on the recording medium (step 125). Thus, the apparatus in effect records the sound beginning at a point A₀ on the sound waveform, which corresponds to t₀=t₁−F_{T}.

The apparatus continues to record the sound on the recording medium until the sound intensity level drops to L2 or below. This occurs at a time t=t₂ and at a point A₂ on the waveform. From this point on, the apparatus stops recording the incoming sound on the recording medium (step 140), and resumes storing the sound in the FIFO (step 110). When the sound level exceeds L1 again, at a time t=t₄ and at a point A₄ on the waveform, the contents of the FIFO are transferred to the recording medium (at step 120), resulting in recording of the sound during the interval (t₄−F_{T})<t<t₄. At a time t=t₄, the apparatus also begins to record the incoming sound on the recording medium (step 125), resulting in a continuous recording of sound from A₃ through A₄ and beyond.

Processes in accordance with the present invention are not limited to making decisions to initiate and stop sound recording (or other sound transfers) based on simple comparisons of the sound intensity level to predetermined thresholds, such as the thresholds L1 and L2 of the process 100. The decisions can be much more involved. For example, the apparatus performing the processes can base the sound-versus-silence decisions on the relationship between the sound level and various moving averages of the sound level. The decisions can also result in a dynamic variation of the length of the sound to be transferred from the FIFO, based on the behavior of the sound attributes. Note that the attributes examined need not be limited to the sound level, but can include, for example, spectral power densities of the sound.

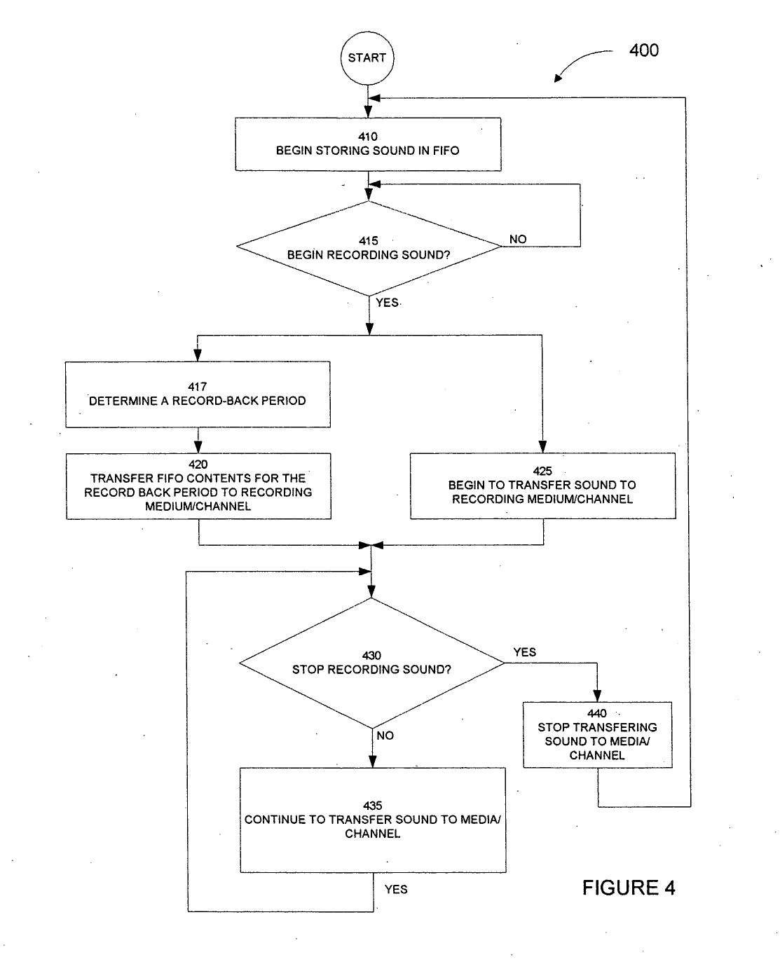

FIG. 4 illustrates selected steps of a process 400 where the decision to start transferring the sound also generates an indication of the length of the pre-decision time interval to be transferred, in accordance with the present invention. At step 410, the storing of sound in the FIFO is initiated. At step 415, the sound attributes, such as sound level and spectral power distribution, are examined and used to determine whether sound transfer should begin. When the sound attributes indicate that sound transfer should begin, process flow advances to step 417 to determine the length of the record-back period. The record-back period is the time interval that immediately precedes the point in time when the transfer of the incoming sound is initiated following the determination that sound transfer should begin.

At step 420, the portion of FIFO contents stored during the record-back period is transferred to a storage medium or to a channel. At step 425 (which can be executed in parallel with the steps 417 and 420), a process for transferring the incoming sound to the storage medium or to the channel is initiated.

While the sound continues to be transferred, the sound attributes and parameters are monitored and decisions whether to continue the sound transfer are continually made, at step 430. As long as the sound attributes indicate that the sound transfer should continue, the sound is transferred to the recording medium and/or through the channel, at step 435. When the sound attributes indicate that the sound transfer should stop, sound transfer is terminated at step 440. The process flow then returns to the steps 410 and 415, storing the incoming sound in the FIFO and monitoring the sound attributes for an indication that sound transfer should begin.

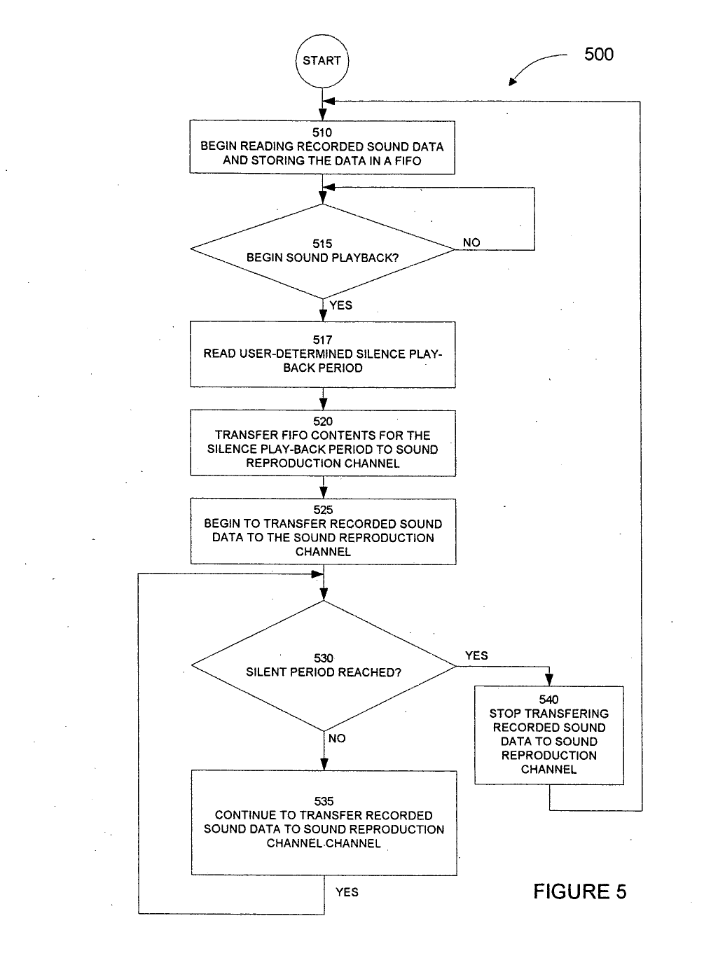

In one embodiment in accordance with the present invention, the user of the recording or reproduction apparatus sets the length of the record-back (or play-back) period manually, for example, by selecting an appropriate menu item and entering the desired value for the record-back period, or by rotating a knob or a dial. FIG. 5 illustrates selected steps of a process 500 for replaying a sound recording with user-selectable suppression of effective silence periods, in accordance with the present invention.

Starting with step 510, the sound reproduction apparatus performing the process 500 begins to read the recorded sound data from the medium on which the data are recorded, and storing the read data in a FIFO. In the illustrated embodiment, the data are recorded digitally, on a memory card, such as a memory stick® or a smartmedia® card. The apparatus reads the sound data from the card at a rate that exceeds the playback rate, at least initially. At step 515, the data are examined for presence of sound, i.e., a decision whether to reproduce the sound represented by the data is made. For example, the apparatus can compare the sound intensity level to a first predetermined level, such as the level L1 of the process 100 of FIG. 1.

When the presence of sound is detected, process flow proceeds to step 517, to determine the length of the play-back period. The play-back period is the time interval immediately preceding the point in time when the presence of sound is indicated in step 515 (or the point in time when transfer of sound is initiated in step 525, discussed below). The play-back period is analogous to the record-back period of process 400. At step 520, the contents of the FIFO accumulated during the play-back period are transferred into a sound reproduction channel. In one exemplary embodiment, the FIFO contents are sent into a buffer that feeds a digital-to-analog converter, which drives an audio amplifier.

The length of the play-back period is set by the user, for example, by selecting a menu item or turning a dial. In some variants of the process 500, the user can change the play-back period at any time. For example, if the user has missed a key word at the beginning of a sound segment, the user can increase the play-back period, rewind, and replay the same sound segment using a longer play-back period.

At step 525, the apparatus begins to transfer the recorded sound data to the same sound reproduction channel. At step 530, the data are examined for presence of another silent period. This can be a simple level comparison, such as the level comparison performed in step 130 of FIG. 1. At step 535, the apparatus continues to transfer the recorded sound data to the sound reproduction channel, e.g., the buffer. When the step 530 indicates that a silent period has been reached, the apparatus stops sending the sound data to the sound reproduction channel. Because the rate of reading the sound data from the card is (or was during some period) higher than the sound reproduction rate, the indication of a silent period may take place when the sound reproduction channel still contains some unplayed sound data in the buffer. The apparatus can therefore continue to reproduce the sound while reading ahead towards the next sound segment.

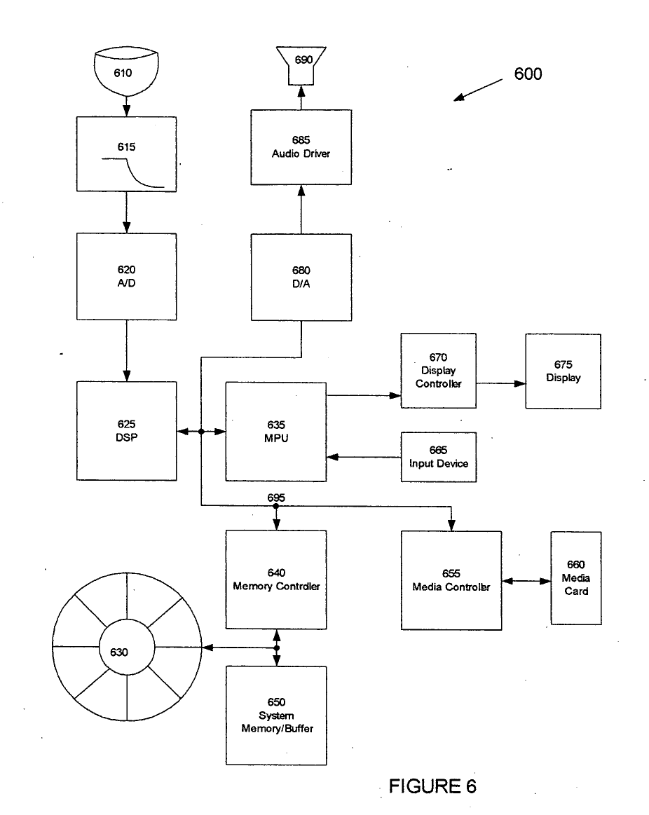

FIG. 6 is a high-level schematic diagram of an exemplary embodiment of a sound recorder and player 600 in accordance with the present invention. A microphone 610 receives the sound to be recorded and transforms the sound into electrical waveforms. The waveforms are bandwidth-limited by a low-pass filter 615 and digitized by an analog-to-digital (A/D) converter 620. A digital signal processor (DSP) 625 receives the digitized audio waveforms, further filters the waveforms, identifies periods of effective silence and sound segments within the waveforms, and digitally compresses the waveforms. The DSP 620 then provides the information regarding the waveform properties and attributes to a microprocessor 635 over a bus 695. Note that the bus 695 also connects to a digital-to-analog (D/A) converter 680, memory controller 640, and media controller 655. The microprocessor 635 decides which portions of the digitized waveforms are stored in the FIFO, and which portions of the waveforms are recorded. The microprocessor 635 then directs the DSP 625 to transfer the digitized waveforms to the memory controller 640 and to the media controller 655. The memory controller 640 transfers the digitized sound to a FIFO 630, while the media controller 655 records the sound segments within the digitized waveforms onto a media card 660. When contents of the FIFO 630 need to be recorded, the microcontroller 635 issues appropriate instructions to the memory controller 640 and the media controller 655, so that these devices transfer the contents of the FIFO to the media card 660. The transfer of FIFO content can be done by direct memory access (DMA) or through the microprocessor 635.

For sound reproduction, the process is reversed. The microprocessor 635 instructs the DSP 625 to read selected content from the media card 660 via the media controller 655. The DSP 625 reads the sound files, uncompresses them and writes the sound data to the memory buffer 650. Based on the determination of sound segments made by the DSP 625, the microprocessor 635 transfers appropriate data from the memory buffer 650 to the D/A converter 680. The D/A converter 680 converts the data into analog waveforms, and sends the waveforms to an audio driver 685. The audio driver 685 amplifies the waveforms and drives a speaker 690, which reproduces the sound.

The sound recorder and player 600 includes a user interface in the form of an input device 665 and a display 675. A display driver 670 provides an interface between the microprocessor 635 and the display 675. In the illustrated embodiment, the input device 665 includes push buttons and a scroll wheel, while the display 675 is an LCD screen.

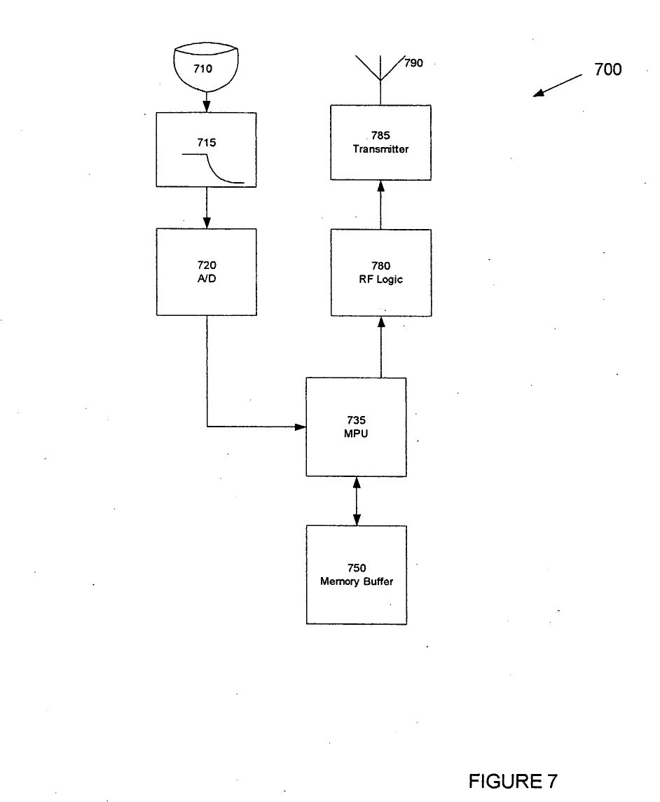

FIG. 7 is a high-level schematic diagram of an exemplary embodiment of a wireless communication device 700 in accordance with the present invention. A microphone 710 receives the sound to be transmitted and transforms the sound into electrical waveforms. The waveforms are bandwidth-limited by a low-pass filter 715 and digitized by an analog-to-digital (A/D) converter 720. A microprocessor 735 receives the digitized audio waveforms, and identifies sound and silence segments within the waveforms. Within the silence segments, the microprocessor 735 determines intervals immediately preceding the sound segments that are to be transmitted together with the sound segments. The microprocessor 735 then hands the sound segments and the intervals to a radio frequency (RF) logic section 780 that assembles frames of data prior to transmission through a transmitter 785 and antenna 790.

As a person skilled in the art would understand, FIGS. 6 and 7 are rather high-level representations of the apparatus in accordance with the present invention. Many components are subsumed within the shown components, or not shown at all. Moreover, the tasks performed by the various components may be assigned to other components. For example, in some variants of the embodiment 600 the functions of the DSP 625, the memory controller 640, and the media controller 655 are performed by the microprocessor 635. Furthermore, the microprocessor 635 can be replaced by a microcontroller and include a display controller, and A/D and D/A converters on-board. A read-only memory (ROM) module that stores the program code executed by the microprocessor/microcontroller can be part of the system memory, or be incorporated on-board the microprocessor or microcontroller of the sound recorder/player.

This document describes the inventive sound transfer methods and devices implementing these methods for illustration purposes only. Neither the specific embodiments of the invention as a whole, nor those of its features limit the general principles underlying the invention. In particular, the invention is not limited to digital storage, recording, and transmission devices, but includes analog devices. The specific features described herein may be used in some embodiments, but not in others, without departure from the spirit and scope of the invention as set forth. Many additional modifications are intended in the foregoing disclosure, and it will be appreciated by those of ordinary skill in the art that in some instances some features of the invention will be employed in the absence of a corresponding use of other features. The illustrative examples therefore do not define the metes and bounds of the invention and the legal protection afforded the invention, which function is served by the claims and their equivalents.

1. A method of transferring sound, comprising:
(a) storing the sound in a buffer;
(b) monitoring one or more sound attributes of the sound for indications of presence of a sound segment in the sound;
(c) transferring the sound in the buffer when the one or more sound attributes produce an indication of sound segment presence; and
(d) transferring the sound after the indication.

2. A method in accordance with claim 1, wherein the step of storing comprises storing the sound in a FIFO.

3. A method in accordance with claim 1, wherein the one or more sound attributes comprise sound intensity level, and first indication is produced when the sound intensity level exceeds a first threshold.

4. A method in accordance with claim 1, wherein the one or more sound attributes comprise spectral power densities of the sound, and the step of monitoring comprises monitoring the spectral power densities.

5. A method in accordance with claim 1, wherein the one or more sound attributes comprise at least one moving average of the sound intensity level, and the step of monitoring comprises monitoring the at least one moving average.

6. A method in accordance with claim 1, further comprising terminating said step (d) when the one or more sound attributes stop producing an indication of sound segment presence.

7. A method in accordance with claim 6, wherein:
said step (c) comprises recording the sound in the buffer on a recording medium when the one or more sound attributes produce the indication of sound segment presence; and
said step (d) comprises recording the sound on the recording medium following the indication of sound segment presence.

8. A method in accordance with claim 6, wherein:
said step (c) comprises transmitting the sound in the buffer when the one or more sound attributes produce the indication of sound segment presence; and
said step (d) comprises transmitting the sound following the indication of sound segment presence.

9. A method in accordance with claim 6, wherein:
said step (c) comprises reproducing the sound in the buffer when the one or more sound attributes produce the indication of sound segment presence; and
said step (d) comprises reproducing the sound following the indication of sound segment presence.

10. A method of transferring incoming sound, comprising:
(a) storing the incoming sound in a buffer;
(b) monitoring one or more attributes of the incoming sound to produce indications of sound segment presence and effective sound absence based on the one or more attributes;
(c) transferring a predetermined interval of the sound in the buffer when the one or more sound attributes produce an indication of sound segment presence, the predetermined interval extending to a point in time when the indication is produced;
(d) transferring the sound following the indication; and
(e) terminating said step (d) when the one or more sound attributes produce an indication of effective sound absence.

11. A method according to claim 10, wherein the step of storing comprises storing the incoming sound in a FIFO.

12. A method in accordance with claim 10, wherein the one or more sound attributes comprise sound intensity level, and the step of monitoring produces an indication of sound segment presence when the sound intensity level exceeds a first threshold.

13. A method in accordance with claim 10, wherein the one or more sound attributes comprise sound intensity level, and the step of monitoring produces an indication of effective sound absence when the sound intensity level is below a first threshold.

14. A method in accordance with claim 10, wherein the one or more sound attributes comprise sound intensity level, the step of monitoring produces an indication of sound segment presence when the sound intensity level exceeds a first threshold, and the step of monitoring produces an indication of effective sound absence when the sound intensity level is below a second threshold.

15. A method in accordance with claim 10, wherein the one or more sound attributes comprise sound intensity level, the step of monitoring produces an indication of sound segment presence when the sound intensity level exceeds a first threshold, and the step of monitoring produces an indication of effective sound absence when the sound intensity level is at or below the first threshold.

16. A method in accordance with claim 10, wherein the step of monitoring comprises monitoring spectral power densities of the sound.

17. A method in accordance with claim 10, wherein the step of monitoring comprises monitoring at least one moving average of the sound intensity level.

18. A method in accordance with claim 10, wherein:
said step (c) comprises recording the sound in the buffer on a recording medium when the step of monitoring produces an indication of sound segment presence; and
said step (d) comprises recording the sound on the recording medium following the indication of sound segment presence.

19. A method in accordance with claim 10, wherein:
said step (c) comprises wirelessly transmitting the sound in the buffer when the monitoring step produces an indication of sound segment presence; and
said step (d) comprises wirelessly transmitting the sound following the indication of sound segment presence.

20. A method in accordance with claim 10, wherein:
said step (c) comprises reproducing the sound in the buffer when the monitoring step produces an indication of sound segment presence; and
said step (d) comprises reproducing the sound following the indication of sound segment presence.

21. A method of sound-activated transfer of incoming sound, the method comprising:
identifying non-overlapping segments of sound and effective sound absence within the incoming sound;
transferring the segments of sound; and
determining a first plurality of intervals within the segments of effective sound absence, each interval immediately preceding one of the segments of sound, each interval being part of and associated with a segment of effective sound absence, the plurality of intervals comprising at least one interval shorter than a segment of effective sound absence associated with said at least one interval; and
transferring the first plurality of intervals.

22. A method in accordance with claim 21, wherein each segment of effective sound absence located between two segments of sound comprises an interval of the first plurality of intervals.

23. A method in accordance with claim 21, further comprising:
defining criteria for determining beginning of a segment of sound; and
defining criteria for determining beginning of a segment of effective sound absence.

24. A method in accordance with claim 21, wherein:
said step of transferring the segments of sound comprises recording the segments of sound; and
said step of transferring the first plurality of intervals comprises recording the first plurality of intervals.

25. A method in accordance with claim 21, wherein:
said step of transferring the segments of sound comprises transmitting the segments of sound; and
said step of transferring the first plurality of intervals comprises transmitting the first plurality of intervals.

26. A method in accordance with claim 21, wherein:
said step of transferring the segments of sound comprises audio reproducing the segments of sound; and
said step of transferring the first plurality of intervals comprises audio reproducing the first plurality of intervals.

27. A method in accordance with claim 21, further comprising dynamically defining lengths of the intervals.

28. A sound recorder, comprising:
an input receiving digitized waveforms representing sound;
a memory storing a program; and
a processor executing the program; and
an interface to a recording medium, the interface being coupled to the processor; wherein:
the processor, under control of the program, determines sound segments within the digitized waveforms, causes the sound segments to be transferred through the interface to be recorded on the recording medium, and causes a plurality of intervals of the digitized waveforms to be transferred through the interface to be recorded on the recording medium, each interval immediately preceding one of the sound segments, at least one interval being shorter than time period between the sound segments immediately following and immediately preceding said at least one interval.

29. A sound recorder in accordance with claim 28, further comprising a microphone capable of receiving the sound and generating analog waveforms corresponding to the sound, and an analog-to-digital converter coupled to the microphone and to the input, the analog-to-digital converter being capable of receiving the analog waveforms and generating the digitized waveforms from the analog waveforms.

30. A sound recorder in accordance with claim 28, further comprising a buffer, wherein the processor causes the intervals to be stored in the buffer before the processor causes the intervals to be recorded on the recording medium.

31. A sound recorder in accordance with claim 30, wherein the buffer comprises a FIFO memory device.

32. A wireless communication device, comprising:
a microphone receiving sound waves and generating electrical waveforms corresponding to the sound waves;
a converter coupled to the microphone to receive the electrical waveforms and convert the electrical waveforms into digitized representations of the sound waves;
a memory storing a program;
a processor executing the program, the processor being coupled to the converter to receive the digitized representations of the sound waves; and
a transmitter;
wherein the processor, under control of the program, (i) determines sound segments and effective silence periods within the digitized representations of the sound waves, (ii) determines a plurality of intervals within the effective silence periods, each interval immediately preceding one of the sound segments, and causes the transmitter to transmit the sound segments and the intervals, while not transmitting portions of the effective silence periods that are outside of the intervals.

33. A wireless communication device in accordance with claim 32, further comprising a buffer where the processor stores the intervals before the processor causes the transmitter to transmit the intervals.
